(19) United States
(12) Patent Application Publication
(10) Pub. No.: US 2026/0225481 A1
(43) Pub. Date: Aug. 6, 2026

(54) HOLSTERS FOR ELECTRIC VEHICLE CHARGERS

(71) Applicant: Rivian IP Holdings, LLC, Irvine, CA (US)

(72) Inventors: Yeon Jae Yoon, Irvine, CA (US); Sanchita Sheth, San Jose, CA (US); Dhaval Palsana, Torrance, CA (US); Hyun Yoo, Santa Ana, CA (US)

(21) Appl. No.: 19/044,289

(22) Filed: Feb. 3, 2025

(51) Int. Cl. B60L 53/30; B60L 53/16; B60L 53/18

(52) U.S. Cl. CPC B60L 53/30; B60L 53/16; B60L 53/18

(57) ABSTRACT

A holster includes a sidewall defining a recess, a hook protruding from the sidewall into the recess, and at least one rib protruding from the sidewall into the recess. The hook and the at least one rib are configured to hold a charging coupler in the recess. A charger for an electric vehicle includes a housing, a charging coupler, and the holster installed in a surface of the housing. The holster is made by arranging a material in a mold and forming the holster in one piece from the material using the mold.

### INTRODUCTION

The present disclosure is directed to holsters for electric vehicle chargers and, more particularly, one-piece holsters that can accommodate different charging connectors.

### SUMMARY

In some embodiments, the present disclosure is directed to a holster to store a charging coupler. In some embodiments, the holster includes a sidewall that defines a recess, a hook protruding from the sidewall into the recess, and at least one rib protruding from the sidewall into the recess. The hook and the at least one rib are configured to hold a charging coupler in the recess. In some embodiments, the hook is arranged opposite to the at least one rib. For example, in some embodiments, the hook has a first height extending into the recess and is configured to interface with at least two different types of charging couplers in the recess. Further, the at least one rib has a second height extending into the recess and is configured to interface with the at least two different types of charging couplers in the recess. In some embodiments, the sidewall, the hook, and the at least one rib are a continuous piece of material formed using a mold.

In some embodiments, the sidewall includes a lateral surface having a first section and a second section extending around the sides of the holster. The first section defines a tapered portion of the recess configured to accommodate the charging coupler, and the hook and the at least one rib extend from the second section into the recess to hold the charging coupler in the recess. In some embodiments, the hook is arranged at a bottom of the second section, and the at least one rib is arranged at a top of the second section. In some embodiments, the sidewall includes a transition section coupling the first section to the second section. In some embodiments, the sidewall need not include a transition section, as the holster may include a single section or may include two sections that meet without a transition or a negligible transition (e.g., a small seam). In some embodiments, the first section and the second section are continuous and without holes such that the lateral surface is leakproof. In some embodiments, the sidewall includes a flange that surrounds an opening of the recess and is configured to interface with a surface of a charger. For example, the flange extends outward from the opening. In some embodiments, the sidewall defines an opening that is configured to allow the charging coupler to enter the recess, and the sidewall has an end face opposite the opening. The end face may include a through hole for mounting the holster.

In some embodiments, the present disclosure is directed to a charger for an electric vehicle. In some embodiments, the charger includes a housing, a charging coupler, and a holster. In some such embodiments, the holster includes a sidewall, a hook, and at least one rib. For example, in some embodiments, the charging coupler is removable from the second section by lifting the charging coupler over the hook and moving the charging coupler out of the second section past the at least one rib. In some embodiments, the sidewall defines an opening configured to allow the charging coupler to enter the recess, the sidewall has an end face opposite the opening, and the sidewall also has a flange that surrounds the opening and is configured to interface with the surface of the housing. In some embodiments, the charger includes a charging cable having a first end and a second end that is arranged opposite to the first end. For example, the first end is coupled to the housing, and the second end is coupled to the charging coupler.

In some embodiments, the present disclosure is directed to a method of making a holster for a vehicle charger. In some embodiments, the method includes arranging a material in a mold, and forming the holster in one piece from the material using the mold. For example, the holster includes a sidewall defining a recess, a hook protruding from the sidewall into the recess, and at least one rib protruding from the sidewall into the recess. In a further example, the hook and the at least one rib are configured to hold a charging coupler in the recess. In some embodiments, the mold includes a mold core configured to define the recess, the hook, and the at least one rib of the holster, and the mold also includes a mold cavity configured to define an outer surface of the holster. In some embodiments, the mold core includes a lifter configured to define at least part of the hook. In some such embodiments, the method includes releasing the mold cavity from the holster after forming, and actuating the lifter using an ejector plate to release the holster from the mold core.

### BRIEF DESCRIPTION OF THE DRAWINGS

The present disclosure, in accordance with one or more various embodiments, is described in detail with reference to the following figures. The drawings are provided for purposes of illustration only and merely depict illustrative embodiments. These drawings are provided to facilitate an understanding of the concepts disclosed herein and shall not be considered limiting of the breadth, scope, or applicability of these concepts. It should be noted that for clarity and ease of illustration these drawings are not necessarily made to scale.

FIG. 1 is a block diagram of an illustrative charger and electric vehicle, in accordance with some embodiments of the present disclosure;

FIG. 2 is a block diagram of the illustrative charger of FIG. 1 with a charging coupler docked and undocked in a holster, in accordance with some embodiments of the present disclosure;

FIG. 3 is a front perspective view of an illustrative holster, in accordance with some embodiments of the present disclosure;

FIG. 4 shows additional front, side, and top views of the illustrative holster of FIG. 3, in accordance with some embodiments of the present disclosure;

FIG. 5 shows cross-sectional views of two different charging couplers docked in an illustrative holster, in accordance with some embodiments of the present disclosure; and

FIG. 6 is a flowchart of an illustrative process for making and using a holster, in accordance with some embodiments of the present disclosure.

### DETAILED DESCRIPTION

In some embodiments, the present disclosure is directed to a cost-effective holster that supports multiple charging coupler types. In some embodiments, the present disclosure is directed to one-piece holster for a North American Charging System (NACS) type charging coupler. In some embodiments, the holster accommodates at least two different designs of the NACS coupler (e.g., both legacy and newer types under the SAE J3400 standard), using a hook and at least one rib to hold the coupler in place when not in use.

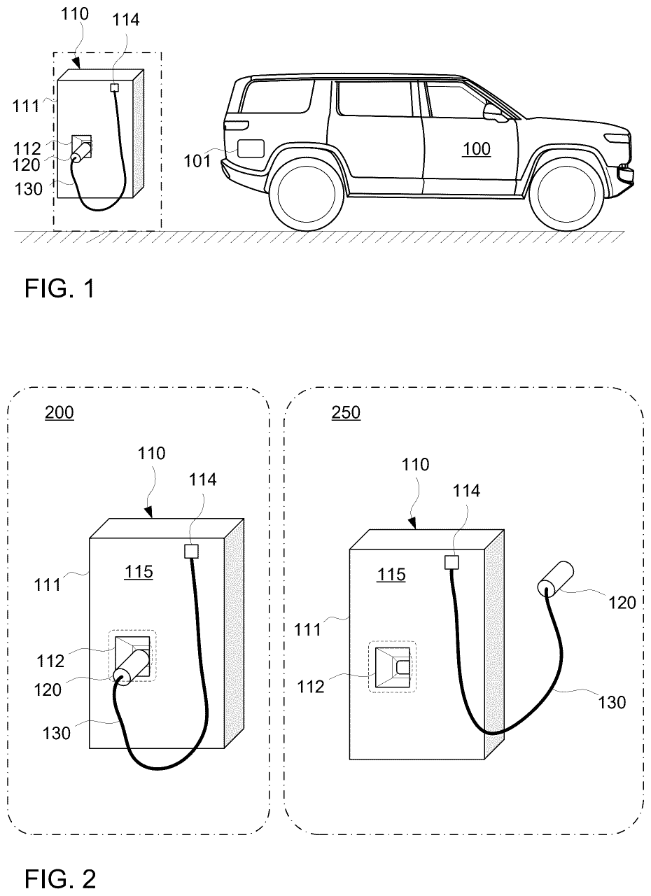

FIG. 1 is a block diagram of illustrative charger 110 and electric vehicle 100, in accordance with some embodiments of the present disclosure. Electric vehicle 100 may include a battery or a battery pack, having any suitable voltage and power capacity. Charger 110 is configured to increase the state of charge (SOC) of the battery or battery pack of electric vehicle 100 (and decrease the SOC when the charger 110 is a bidirectional charger and electric vehicle 100 is being used to power, for example, a home). For example, electric vehicle 100 may be positioned near charger 110 (e.g., mounted to a wall or structure in a garage, parking stall, or other suitable facility), and charging coupler 120 may be de-docked from charger 110 and coupled to port 101 of electric vehicle 100. Cable 130 is a charging cable that extends between housing 111 of charger 110 at a first end (e.g., at interface 114, which may include a strain relief, connector interface, seal, movable joint, reel, or any other suitable component) and charging coupler 120 at a second end, and is flexible to allow manipulation between holster 112 and port 101 of electric vehicle 100. Housing 111 may include a body of charger 110, exterior surfaces of charger 110, any suitable portion thereof, or any combination thereof. Interface 114 may be integral to housing 111, or may be affixed or otherwise engaged with housing 111. In some embodiments, charger 110 may be coupled to an electric grid. For example, charger 110 may be coupled to one or more circuits of a circuit breaker or main panel in a residence. Charger 110 may provide or receive AC power, DC power, control signals, or a combination thereof to electric vehicle 100 (e.g., an onboard charger thereof). In some embodiments, cable 130 may be detachable from housing 111 using interface 114.

FIG. 2 is a block diagram of illustrative charger 110 of FIG. 1 with charging coupler 120 docked (panel 200) and undocked (panel 250) in holster 112, in accordance with some embodiments of the present disclosure. When not being used for charging, charging coupler 120 may be secured in holster 112. While secured, holster 112 prevents charging coupler 120 from falling or otherwise becoming de-docked from incidental disturbances or forces. For example, holster 112 may include at least one rib, at least one hook, or other suitable features for securing charging coupler 120. When ready for use, charging coupler 120 may be de-docked from holster 112 by a user by applying a suitable amount of force and guiding charging coupler 120 through a suitable trajectory. For example, when ready for use, a user may take hold of charging coupler 120, lift it slightly and rotate the end face down slightly, and then pull charging coupler 120 out of holster 112 along a straight or substantially straight path. Accordingly, when charging coupler 120 is docked in holster 112, a simple downward, upward, or lateral force will not de-dock charging coupler 120. After use, charging coupler 120 may be re-docked into holster 112 by reversing the trajectory - translating charging coupler 120 into holster 112 and then slightly rotating charging coupler 120 to seat it against one or more features of holster 112 (e.g., a hook, rib, or combination thereof). As illustrated, holster 112 is installed at surface 115 of charger 110, which may be any suitable exterior surface of housing 111.

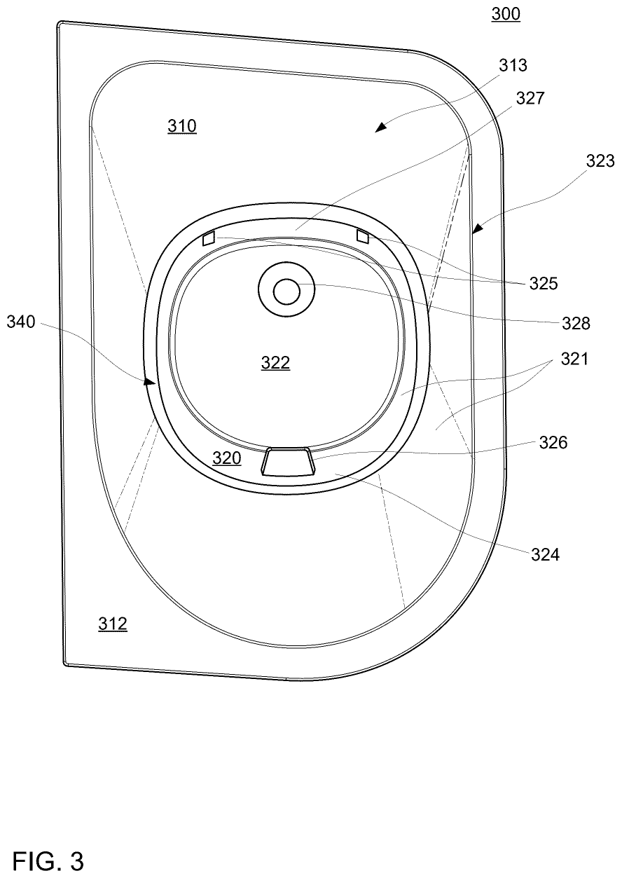

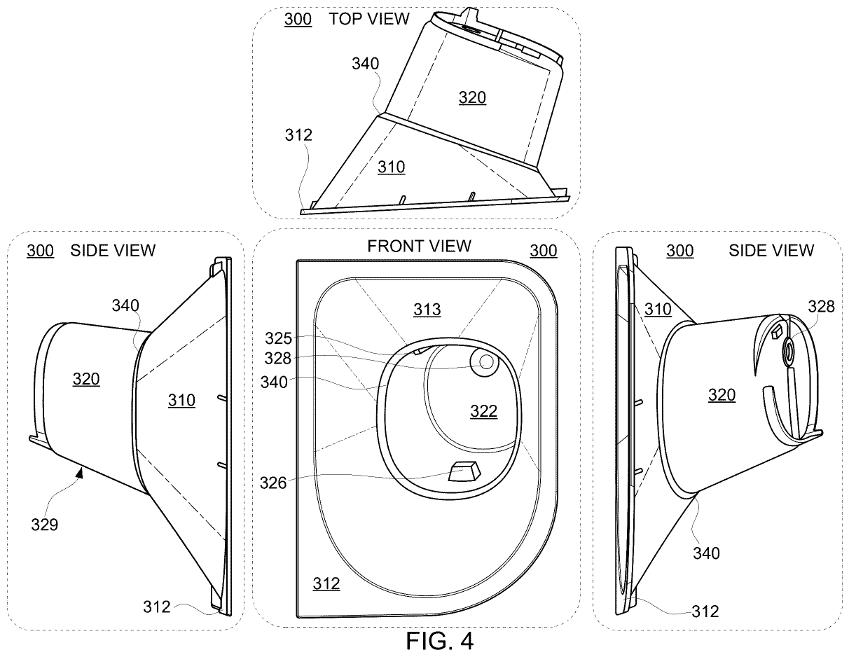

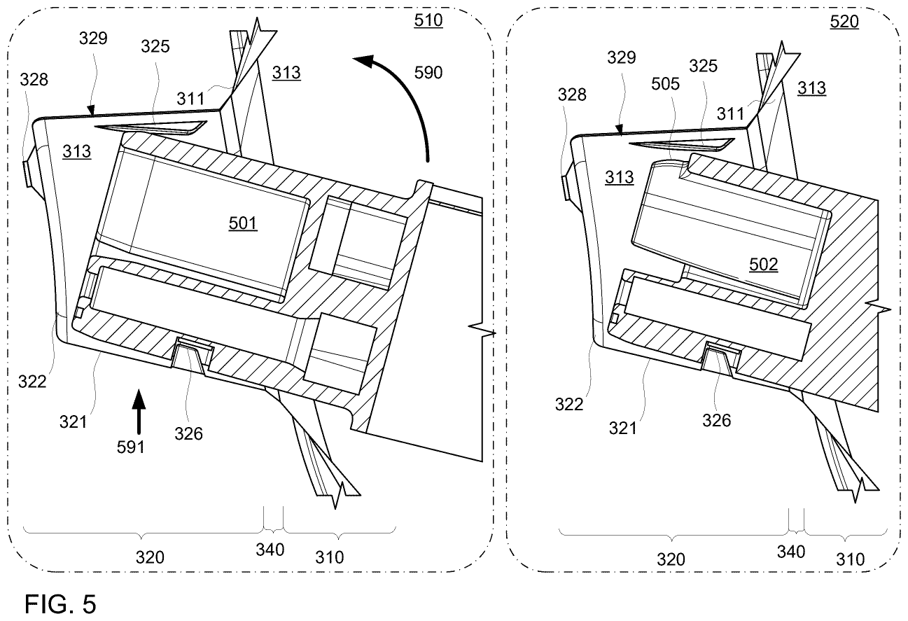

FIG. 3 is a front perspective view of illustrative holster 300, in accordance with some embodiments of the present disclosure. FIG. 4 shows additional front, side, and top views of illustrative holster 300 of FIG. 3, in accordance with some embodiments of the present disclosure. FIG. 5 shows cross-sectional views of two different charging couplers (e.g., first and second charging couplers 501 and 502) docked in illustrative holster 300 of FIGS. 3-4, in accordance with some embodiments of the present disclosure. As illustrated, holster 300 does not include any moving parts such as a latch or mechanism. Holster 300 is configured to secure a charging coupler using features such as hook 326 and ribs 325. As illustrated in FIGS. 3-5, a holster or charging including a holster may include:
first section 310;
flange 312;
recess 313;
second section 320;
lateral surface 321;
end face 322;
opening 323;
bottom section 324;
ribs 325;
hook 326;
top section 327;
hole 328;
sidewall 329;
transition section 340;
first charging coupler 501; and
second charging coupler 502.

As illustrated, holster 300 includes a tapered recess having two sections (e.g., first section 310 and second section 320, joined by transition section 340). In some embodiments, transition section 340 is omitted (e.g., first section 310 is adjacent to second section 320, without any substantial transitioning). First section 310 is a lead in and is tapered (e.g., defining a tapered portion of recess 313) to direct a coupler into and out of holster 300. Second section 320 includes hook 326 and at least one rib (e.g., ribs 325) to hold the coupler. Lateral surface 321, which includes first and second sections 310 and 320 (e.g., extending around the top, bottom, and lateral sides) is continuous, without holes or otherwise openings. As illustrated, sidewall 329 includes end face 322, opposite the main opening (e.g., opening 323 through which the coupler is inserted and removed), may include a single hole (e.g., hole 328, which may be a through hole) for mounting holster 300 against a frame member (e.g., a structural member of the charger). Because this single hole (e.g., hole 328) may be sealed using a sealed fastener (e.g., a fastener with a gasket or compliant material, or a sealant), when installed, holster 300 is leakproof at end face 322 and lateral sides. Opposite end face 322 is flange 312, which is configured to interface with a wall of the charger (e.g., a planar face such as a side of the charger), such that holster 300 forms recess 313 into the wall to store the charging coupler. Opening 323 is defined by the meeting of flange 312 and lateral surface 321, and opening 323 is configured to accommodate the charging coupler into recess 313 (e.g., opening 323 allows the charging coupler to enter recess 313). In some embodiments, sidewall 329 includes flange 312 that surrounds opening 323 of the recess 313 and is configured to interface with a surface of a charger (e.g., charger 110 of FIG. 1). For example, as illustrated, flange 312 extends outward from opening 323.

First section 310, second section 320, and transition section 340 of lateral surface 321 form recess 313, which tapers from opening 323 of recess 313 to end face 322. Hook 326 and ribs 325 are configured to engage the charging coupler (e.g., surfaces or features thereof) to secure the coupler in recess 313 while allowing it to be de-docked along a trajectory. For example, a charging coupler may be removable from second section 320 by lifting the charging coupler over hook 326 and moving the charging coupler out of the second section past the at least one rib (e.g., ribs 325). In some embodiments, as illustrated, hook 326 and ribs 325 protrude from sidewall 329 into recess 313. Sidewall 329 refers to the totality of the solid body of holster 300, except for hook 326, ribs 325, and any holes, recesses, or volumes (e.g., sidewall 329 includes only the holster material forming the walls, end face 322, and flange 312). Lateral surface 321 of sidewall 329 defines recess 313. First section 310 defines a tapered portion of recess 313 configured to accommodate a charging coupler, and hook 326 and the at least one rib (e.g., ribs 325) extend from second section 320 into recess 313 to hold the charging coupler in the recess. As illustrated, hook 326 is arranged opposite to at least one rib (e.g., ribs 325). For example, hook 326 may be arranged at a bottom of second section 320 (e.g., bottom section 324), and the at least one rib (e.g., ribs 325) is arranged at a top of second section 320 (e.g., top section 327).

In some embodiments, holster 300 is one-piece, formed from a single piece of material (e.g., using a molding process such as at least some of process 600). For example, because holster 300 may be a single piece, its construction is relatively simple and there are no seams or interfaces to loosen or leak. In a further example, first section 310 and second section 320 (e.g., and transition section 340, if included) are continuous and without holes or openings such that lateral surface 321 is leakproof. In some embodiments, for example, sidewall 329, hook 326, and the at least one rib (e.g., ribs 325) are a continuous piece of material formed using a mold (e.g., using process 600). In a further example, aside from hole 328 which may itself be sealed when installed, there are no openings, holes, or through intrusions in sidewall 329. Accordingly, holster 300 may be installed in a charger, and no other connections or intrusions need be made into recess 313 (e.g., other than docking a charging coupler through opening 323).

Panel 510 of FIG. 5 illustrates a first configuration in which first charging coupler 501 is secured in holster 300. For example, first charging coupler 501 may be a legacy North American Charging System (NACS) type coupler configured for AC or DC charging (e.g., a charging coupler designed prior to SAE J3400 standardization). In a further example, first charging coupler 501 may include two terminals configured to provide either DC or AC charging (e.g., DC +/−, L1/L2, or L1/N connections), a ground terminal, a control pilot terminal, and a proximity pilot terminal. In some embodiments, when ready for use, a user may take hold of charging coupler 501, lift it slightly over hook 326 (e.g., movement 591) and rotate the end face down slightly to clear ribs 325 (e.g., movement 590), and then pull charging coupler 501 out of holster 300 along a straight or substantially straight path. A similar trajectory may be used for charging coupler 502 of panel 520. Panel 520 illustrates a second configuration in which second charging coupler 502 is secured in holster 300. Second charging coupler 502 may be a North American Charging System (NACS) type coupler configured for AC or DC charging under the SAE J3400 standard. In a further example, second charging coupler 502 may include two terminals configured to provide either DC or AC charging (e.g., DC +/−, L1/L2, or L1/N connections), a ground terminal, a control pilot terminal, and a proximity pilot terminal. Second charging coupler 502 may have less material at its terminal end than first charging coupler 501 (e.g., and accordingly may rest in a slightly different position when secured). To illustrate, a charger for an electric vehicle may include holster 300, and one of first charging coupler 501, second charging coupler 502, or any other suitable charging coupler that may dock to holster 300. Because holster 300 accommodates connectors designed both pre and post SAE J3400, a single holster design may accommodate more than one type of charger or charger installation (e.g., charger 110 may be substantially the same even if a different type of charging coupler 120 is installed). In an illustrative example, a SAE J3400 type connector (e.g., second charging coupler 502) may include two cylindrical bodies 505 (e.g., only a single body is visible in the cross-sectional view of FIG. 5) that extend from the main coupler body, each surrounding a DC +/− or L1/L2 pin, and each rib of ribs 325 may align with one of the bodies 505 (e.g., two ribs corresponding to the two bodies) to secure second charging coupler 502 in recess 313.

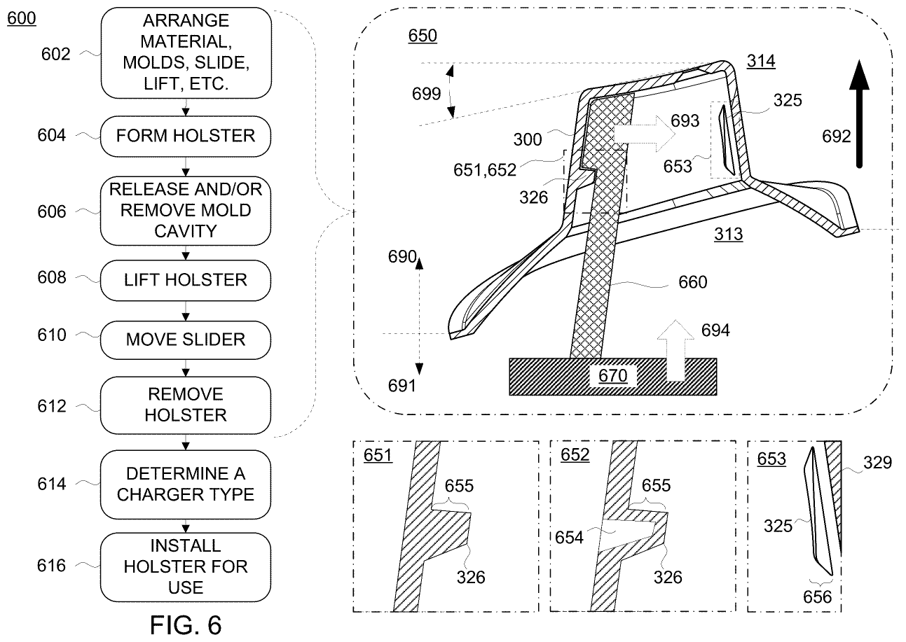

FIG. 6 is a flowchart of illustrative process 600 for making and using a holster, such as holster 300 of FIGS. 3-5, in accordance with some embodiments of the present disclosure. As illustrated in panel 650, the following disclosure of process 600 may refer to:
cavity side 690;
core side 691;
drafting direction 692;
movement 693; (e.g., 9 mm)
movement 694;
angle 699; (e.g., 15 degrees)
undercut 655; (e.g., 8 mm)
lifter 660;
ejector plate 670;
panel 650;
insets 651-653; and
recess 654.

Step 602 includes arranging material, molds, slides, lifters, any other suitable components, or any combination thereof. For example, the mold may include a mold core and mold cavity, and the material may include a blank or injectable material. The material may include any suitable plastic material, composite material, or a combination thereof, for example. In some embodiments, step 602 includes arranging the mold, one or more slides, and one or more lifters, and then preparing arranging the material.

Step 604 includes forming holster 300 from the material of step 602, using any suitable equipment, technique, or combination thereof. In some embodiments, step 604 includes allowing an injected material to harden. In some embodiments, step 604 may include forming a solid blank of material (e.g., stamping).

Step 606 includes removing, releasing, or both, a mold cavity after holster 300 is formed at step 604. For example, because holster 300 has a concave side (e.g., defining recess 313) and a convex side (e.g., defining outer surface 314), the mold cavity may be arranged on cavity side 690.

Step 608 includes lifting holster 300 off of a mold core after the mold cavity is removed. For example, the mold core may be arranged on core side 691, and may be suitably shaped with lifter 660 to define recess 313. Lifter 660 is movable relative to the mold core and is configured to lift holster 300 off of the mold core, using ejector plate 670 (e.g., illustrated by movement 694). To illustrate, because hook, 326 protrudes into recess 313, holster 300 could not be lifted straight off of the mold core if lifter 660 were not movable.

Inset 651 illustrates undercut 655, wherein the back side of hook 326 is not recessed on outer surface 314. In some embodiments, lifter 660 may move in the drafting direction 692, or at an angle relative to drafting direction 692, or a combination thereof (e.g., along a trajectory), during step 608. Inset 652 also illustrates undercut 655, where the back side of hook 326 is recessed from outer surface 314. For example, if the back side of hook 326 is recessed (e.g., recess 654 is formed), then a slider may be used on the cavity side 690 to release the back side of hook 326 (e.g., recess 654) prior to lifting holster 300 at step 608. Inset 653 illustrates one of ribs 325 extending a distance 656 into recess 313 from sidewall 329. In an illustrative example, a hook (e.g., hook 326) may include a first height extending into the recess (e.g., undercut 655 into recess 313) and may be configured to interface with and secure at least two types of charging couplers in the recess (e.g., first and second charging couplers 501 and 502). Further, the at least one rib (e.g., either or both of ribs 325) may include a second height (e.g., equal to distance 656) extending into the recess (e.g., recess 313) and may be configured to interface with and secure the at least two types of charging couplers in the recess (e.g., first and second charging couplers 501 and 502).

Step 610 includes moving a slider to release the holster. In some embodiments, lifter 660 is configured to slide, as illustrated by movement 693. Once holster 300 is lifted at step 608, lifter 660 may then be translated out of the way. For example, lifter 660 may undergo movement 693, which may be about 9 mm if hook 326 includes undercut 655 of about 8 mm (e.g., protrudes into recess 313 by a distance equal to undercut 655), such that hook 326 clears lifter 660 when removed in drafting direction 692. After movement 693, hook 326 may clear lifter 660 and be removed in the drafting direction 692.

Step 612 includes removing holster 300 from the mold system. In some embodiments, ejector plate 670, lifter 660, or a combination thereof may be configured to release holster 300 (e.g., using air pressure or a mechanical release). In some embodiments, holster 300 may be manually removed from the mold system. Process 600 may, but need not, include any further processing steps of holster 300. For example, process 600 may include painting, sanding, trimming, etching, labeling, measuring, performing quality control, any other suitable processing, or any combination thereof, of holster 300 in preparation for installation. In some embodiments, step 610, step 612, or a combination thereof may include actuating lifter 660 using ejector plate 670 to release holster 300 from the mold core.

Step 614 includes determining a charger type. For example, a wall charger, such as a residential charger, may include holster 300, but may include a particular type of charging coupler selected from a plurality of couplers (e.g., first or second charging couplers 501 and 502, or any other suitable coupler). In some embodiments, different charger types may include holster 300, but differing in power electronics systems for charging, coupler type, or a combination thereof. For example, referencing FIG. 1, step 614 may include determining a type of charger 110.

Step 616 includes installing holster 300 in a suitable charger for use (e.g., to secure a charging coupler), such as charger 110 of FIG. 1, for example. Step 616 may include fastening holster 300 to a structure of the charger (e.g., using hole 328), such as a frame or rail (e.g., housing 111 of charger 110, which may be or otherwise include a housing). In some embodiments, flange 312 may be interfaced to a surface of the charger (e.g., surface 115 of charger 110 of FIG. 1) such that it is parallel with the surface (e.g., offset or flush). In some embodiments, step 616 includes applying an adhesive, sealant, self-tapping fastener, any other suitable material or component, or any combination thereof to install holster 300. In some embodiments, one or more features of holster 300 may aligned to a mating feature of the charger.

In an illustrative example of process 600, a holster may be formed by molding, using a mold having one or more lifters, one or more sliders, or a combination thereof. For example, a single slider may be used to form the hook. On the interior of the holster, a single lift may be used, arranged at the hook feature because it protrudes into the central cavity.

The foregoing is merely illustrative of the principles of this disclosure and various modifications may be made by those skilled in the art without departing from the scope of this disclosure. The above-described embodiments are presented for purposes of illustration and not of limitation. The present disclosure also can take many forms other than those explicitly described herein. Accordingly, it is emphasized that this disclosure is not limited to the explicitly disclosed methods, systems, and apparatuses, but is intended to include variations to and modifications thereof, which are within the spirit of the following claims.

What is claimed is:

1. A holster, comprising:
a sidewall defining a recess;
a hook protruding from the sidewall into the recess; and
at least one rib protruding from the sidewall into the recess, wherein the hook and the at least one rib are configured to hold a charging coupler in the recess.

2. The holster of claim 1, wherein the hook is arranged opposite to the at least one rib.

3. The holster of claim 1, wherein the sidewall comprises a lateral surface comprising:
a first section defining a tapered portion of the recess configured to accommodate the charging coupler; and
a second section, wherein the hook and the at least one rib extend from the second section into the recess to hold the charging coupler in the recess.

4. The holster of claim 3, wherein:
the hook is arranged at a bottom of the second section; and
the at least one rib is arranged at a top of the second section.

5. The holster of claim 3, wherein the sidewall further comprises a transition section coupling the first section to the second section.

6. The holster of claim 3, wherein the first section and the second section are continuous and without holes such that the lateral surface is leakproof.

7. The holster of claim 1, wherein the sidewall comprises a flange surrounding an opening of the recess and configured to interface with a surface of a charger, wherein the flange extends outward from the opening.

8. The holster of claim 1, wherein:
the sidewall defines an opening configured to allow the charging coupler to enter the recess; and
the sidewall comprises an end face opposite the opening, wherein the end face comprises a through hole for mounting the holster.

9. The holster of claim 1, wherein:
the hook comprises a first height extending into the recess and configured to interface with at least two types of charging couplers in the recess; and
the at least one rib comprises a second height extending into the recess and configured to interface with the at least two types of charging couplers in the recess.

10. The holster of claim 1, wherein the sidewall, the hook, and the at least one rib are a continuous piece of material formed using a mold.

11. A charger for an electric vehicle, the charger comprising:
a housing;
a charging coupler; and
a holster installed in a surface of the housing, the holster comprising:
a sidewall defining a recess;
a hook protruding from the sidewall into the recess; and
at least one rib protruding from the sidewall into the recess, wherein the hook and the at least one rib are configured to hold the charging coupler in the recess.

12. The charger of claim 11, wherein the hook is arranged opposite to the at least one rib.

13. The charger of claim 11, wherein the sidewall comprises a lateral surface comprising:
a first section defining a tapered portion of the recess configured to accommodate the charging coupler; and
a second section, wherein the hook and the at least one rib extend from the second section into the recess to hold the charging coupler in the recess, wherein the first section and the second section are continuous and without holes such that the lateral surface is leakproof.

14. The charger of claim 13, wherein the charging coupler is removable from the second section by lifting the charging coupler over the hook and moving the charging coupler out of the second section past the at least one rib.

15. The charger of claim 11, wherein:
the sidewall defines an opening configured to allow the charging coupler to enter the recess;
the sidewall comprises an end face opposite the opening; and
the sidewall comprises a flange surrounding the opening and configured to interface with the surface of the housing.

16. The charger of claim 11, wherein:
the hook comprises a first height extending into the recess and configured to interface with at least two types of charging couplers in the recess; and
the at least one rib comprises a second height extending into the recess and configured to interface with the at least two types of charging couplers.

17. The charger of claim 11, further comprising a charging cable comprising a first end and a second end arranged opposite to the first end, wherein the first end is coupled to the housing, and wherein the second end is coupled to the charging coupler.

18. A method of making a holster for a vehicle charger, the method comprising:
arranging a material in a mold; and
forming the holster in one piece from the material using the mold, wherein the holster comprises:
a sidewall defining a recess;
a hook protruding from the sidewall into the recess; and
at least one rib protruding from the sidewall into the recess, wherein the hook and the at least one rib are configured to hold a charging coupler in the recess.

19. The method of claim 18, wherein the mold comprises:
a mold core configured to define the recess, the hook, and the at least one rib of the holster; and
a mold cavity configured to define an outer surface of the holster.

20. The method of claim 19, wherein the mold core further comprises a lifter configured to define at least part of the hook, the method further comprising:
releasing the mold cavity from the holster after forming; and
actuating the lifter using an ejector plate to release the holster from the mold core.
